(19) United States
(12) Patent Application Publication
(10) Pub. No.: US 2010/0277273 A1
(43) Pub. Date: Nov. 4, 2010

(54) SYSTEM AND METHOD FOR ASSIGNING DRIVER STATUS TO A SPARE KEY AND FOR PROGRAMMING THE SPARE KEY TO A VEHICLE

(75) Inventors: Thomas Lee Miller, Ann Arbor, MI (US); Kevin Thomas Hille, Plymouth, MI (US); Scott Alan Watkins, Sterling Heights, MI (US); Martin J. Sultana, Dearborn, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/433,642

(22) Filed: Apr. 30, 2009

(51) Int. Cl. G08B 29/00

(52) U.S. Cl. 340/5.6

(57) ABSTRACT

In at least one embodiment, a method and device for assigning a driver status of one of a primary driver and a secondary driver to a spare key is provided. A controller is configured to receive a first key identification signal from a first key indicative of the driver status for the first key being that of one of the primary and the secondary driver. The controller is configured to determine whether the driver status indicated on the first key identification signal corresponds to the one of the primary driver and the secondary driver. The controller is configured to receive a spare key identification signal and assign the spare key identification signal to correspond to the driver status as indicated on the first key identification signal.

### BACKGROUND

1. Technical Field

One or more embodiments described herein generally relate to a system and method for assigning driver status to a spare key and for programming the spare key to a vehicle.

2. Background Art

With conventional automotive vehicles, one or more keys are often shared between any number of drivers. For example, the parents of a teenager (or young adult) that is old enough to drive may share the keys for the vehicle with the teenager. The vehicle may be equipped with various safety and/or driver notification features that may be enabled/disabled via a user interface based on the driver's needs. However, in some circumstances, the parent may not intend to have the various safety and notification related features disabled by the teenager. The parent may enable the safety and notification features prior to allowing the teenager to drive the vehicle, however there is no guarantee that the teenager may keep the safety and notification features enabled while driving the vehicle. Conventional vehicles fail to give parents, or other such primary drivers, the option of preventing teenagers eligible to driver or other such secondary drivers from disabling safety and notification features.

In light of the foregoing, it is generally necessary to differentiate between the drivers so that a determination can be made as to when a particular vehicle system should prevent the disabling of such safety and notification features (or other features) in the event the driver is detected to be a teenager or other such secondary driver. Further, such a determination may be needed to ensure that the primary driver is allowed to disable the safety and notification features as desired. As recognized, the safety and notification features are generally arranged such that a primary driver may disable the features in the event such features are not desired and are not mandatorily imposed by law or other such ordinance.

It is generally recognized that vehicle owners need a mechanism to program a spare key to a vehicle. There are known systems that enable the vehicle owner (or other occupant) to program a spare key to the vehicle owner so that the vehicle owner is not required to go to a vehicle dealership or mechanic shop to have the programming step performed. While these systems that enable the vehicle owner to program a spare key are particularly useful, such systems do not take into account driver status when programming a spare key to the vehicle.

### SUMMARY

In at least one embodiment, a method and a device for assigning a driver status of one of a primary driver and a secondary driver to a spare key is provided. A controller is configured to receive a first key identification signal from a first key indicative of the driver status for the first key being that of one of the primary and the secondary driver. The controller is further configured to determine whether the driver status indicated on the first key identification signal corresponds to the one of the primary driver and the secondary driver. The controller is further configured to receive a spare key identification signal and assign the spare key identification signal to correspond to the driver status as indicated on the first key identification signal.

### BRIEF DESCRIPTION OF THE DRAWINGS

FIG. 1 depicts a system for programming a spare key to a vehicle in accordance to one embodiment of the present invention;

FIG. 2 depicts a system for programming the spare key to the vehicle in accordance to another embodiment of the present invention;

FIG. 3 depicts a method for programming the spare key to the vehicle in accordance to one embodiment of the present invention; and

FIG. 4 depicts a method for programming the spare key to the vehicle in accordance to another embodiment of the present invention.

### DETAILED DESCRIPTION

Primary and secondary drivers may be determined in one or more embodiments of the present invention and various levels of control are granted to the driver based on whether the driver is the primary driver or the secondary driver. In general, the primary driver (e.g, a parent, employer, or consumer of valet services) may be defined as the administrative driver who has greater control over the functionality of various features in the vehicle. The secondary driver (e.g., teenager, employee, or valet driver) may be defined as a restricted driver who has limited control over various features generally provided by the vehicle and is to abide by the functional restrictions imposed or selected by the vehicle or the primary driver. The embodiments of the present invention provide a system and method for assigning driver status (e.g., primary driver status and secondary driver status) to a spare key and for programming the spare key to a vehicle. Such a system and method as set forth herein may, among other things, prevent the secondary driver from programming a spare key to become a primary key so that the secondary driver can use the programmed primary key to achieve greater control over the functionality offered than that typically granted or authorized for the secondary driver.

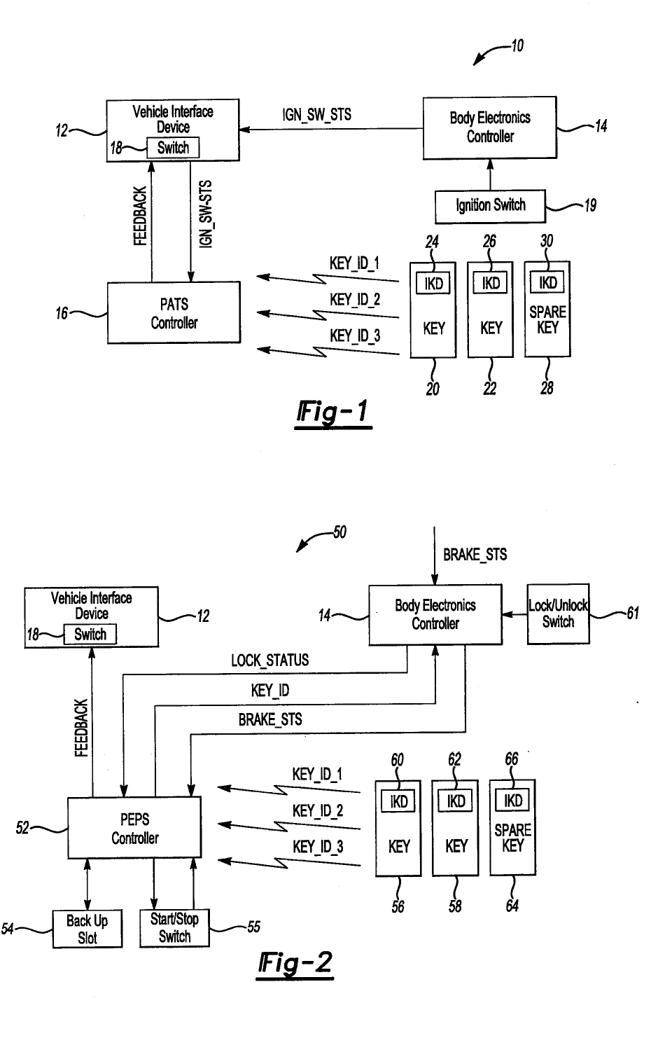

The embodiments of the present invention as set forth in FIGS. 1-4 generally illustrate and describe a plurality of controllers (or modules), or other such electrically based components. All references to the various controllers and electrically based components and the functionality provided for each, are not intended to be limited to encompassing only what is illustrated and described herein. While particular labels may be assigned to the various controllers and/or electrical components disclosed, such labels are not intended to limit the scope of operation for the controllers and/or the electrical components. The controllers (or modules) may be combined with each other and/or separated in any manner based on the particular type of electrical architecture that is desired or intended to be implemented in the vehicle. It is generally recognized that each controller and/or module disclosed herein may include, but not limited to, any number of microprocessors, ASICs, ICs, memory devices (e.g., FLASH, ROM, RAM, EPROM and/or EEPROM), and software which co-act with one another to perform the various functions set forth below.

Referring now to FIG. 1, a system 10 for programming a spare key to a vehicle in accordance to one embodiment of the present invention is shown. The system 10 includes a vehicle interface device 12, a body electronics controller 14, and a passive anti-theft security (PATS) controller 16. The vehicle interface device 12 may be implemented as a message center on an instrument cluster or as a touch screen monitor such that the device 12 is generally configured to present text, menu options, status or other such data to the driver in a visual format. A driver may scroll through various fields of text and select menu options via at least one switch 18 positioned about the device 12. The switch 18 may be remotely positioned away from the device 12 or positioned directly thereon. It is recognized that the device 12 may be any apparatus that is generally situated to provide information and receive feedback to/from a vehicle occupant. The switches 18 may be in the form of voice commands, touch screen, and/or other external devices (e.g., phones, computers, etc.) that are generally configured to communicate with the electrical system of the vehicle.

The device 12, the PATS controller 16, and the body electronics controller 14 may communicate with each other via a communication bus. The communication bus may be implemented as a High/Medium Speed Controller Area Network (CAN) bus, a Local Interconnect Network (LIN), or other suitable data link communication bus generally situated to facilitate data transfer between controllers (modules) in the vehicle.

The body electronics controller 14 generally controls at least a portion of the electrical content in an interior section of the vehicle. In one example, the body electronic controller 14 may be a smart power distribution junction box (SPDJB) controller. The SPDJB controller may include a plurality of fuses, relays, receivers/transmitters, and various microcontrollers for performing any number of functions related to the operation of the interior and/or exterior electrically based vehicle functionality. Such functions may include but not limited to electronic unlocking/locking (via interior door lock/unlock switches), remote keyless entry operation, vehicle lighting (interior and/or exterior), electronic power windows, and/or key ignition status (e.g., Off, Rn, Start, Accessory (ACCY).

An ignition switch 19 may be operably coupled to the body electronics controller 14. The body electronics controller 14 may receive hardwired signals indicative of the position of the ignition switch 34 and may transmit data messages on the communication bus that are also indicative of the position of the ignition switch. For example, the body electronics controller 14 may transmit a signal IGN_SW_STS over the communication bus to the vehicle interface device 12. The signal IGN_SW_STS generally corresponds to whether one of the keys 20, 22 has been inserted into the key ignition switch and to the position of the ignition switch (e.g., Off, Run, Start, or Accessory positions) with the key 20,22 inserted therein.

The ignition switch 19 may receive the programmed keys 20,22 to start the vehicle. Each key 20, 22 includes an ignition key device (IKD) 24, 26, respectively embedded therein for communicating with the vehicle. Each IKD 24, 26 includes a transponder (not shown). Each transponder includes an integrated circuit and an antenna. Each transponder with the keys 20, 22 is adapted to transmit signals KEY_ID_1 and KEY_ID_2, respectively, in the form of radio frequency (RF) signals to a receiver (not shown) in the PATS controller 16. Each signal KEY_ID_1 and KEY_ID_2 comprises data that corresponds to a manufacturer code, a corresponding key serial number and encrypted data for the respective key 20, 22. The key serial number and the encrypted data are used to authorize an engine controller (not shown) to start the vehicle in the event the encrypted data corresponds to predetermined encrypted data stored in a look up table (LUT) of the PATS controller 16. The PATS controller 16 may use the key number and/or the encrypted data transmitted on the signals KEY_ID_1 and KEY_ID_2 to determine if the key is a primary key or a secondary key. In general, the driver who holds the primary key is presumed to be the primary driver (e.g., the parent, employer, or consumer of valet services). The driver who holds the secondary key is presumed to be the secondary driver (e.g., the teenager, employee or valet driver). The manufacturer code generally corresponds to the identify of the manufacturer. For example, the manufacturer code may correspond to Ford Motor Company. Such a code prevents a technician from mistakenly configuring a key with a manufacturer code of another vehicle manufacturer to a Ford vehicle. The PATS controller 16 may monitor the manufacturer code information at the time in which the keys 20,22 are programmed to the vehicle. An example of a LUT that may be stored in the PATS controller 16 is shown in TABLE 1 directly below.

TABLE 1

| KEY | MAN. | | |
|---|---|---|---|
| SERIAL # | CODE | ENCRYPTED DATA | TYPE |
| 1xxA | Ford | #$#$#$#$#$#$#$# | Primary |
| 2xxB | Ford | #######$$$$$$$$ | Secondary |
| NnnN | Ford | $#$#$#$#$#$#$#$ | Secondary |
| EMPTY | EMPTY | EMPTY | EMPTY |

The LUT may include data for any number of keys. To start the vehicle, the PATS controller 16 decodes the key serial number and corresponding encrypted data received either on the signal KEY_ID_1 or KEY_ID_2 and compares such data to the key serial number and the encrypted data in the LUT to determine whether such data matches prior to starting the vehicle for anti-theft purposes. In the event the data matches, the engine controller allows the vehicle to start the engine.

To determine driver status, the PATS controller 16 decodes the key number and/or the encrypted data received on the signal KEY_ID_1 or KEY_ID_2 and reads the corresponding key status (e.g., primary or secondary) next to the key number and/or the encrypted data as shown under the heading ‘TYPE’ of Table 1 to determine whether the key is the primary key or the secondary key (or whether the driver is the primary or the secondary driver). The primary driver is presumed to be the holder of the primary key in the event the primary key is detected. The secondary driver is presumed to be the holder of the secondary key in the event the secondary key is detected. The PATS controller 16 transmits a signal KEY_STATUS to the vehicle interface device 12 to indicate whether the key is the primary key or the secondary key. The PATS controller 16 and/or the device 12 may transmit the signal KEY_STATUS to any controller or module in the vehicle so that the functionality or operation performed by a particular controller (or module) may be selectively controlled based on the key status (or the driver status). For example, seat belt minder, fuel level indicator, reverse park aid, object detection, and traction control as found in U.S. patent Ser. Nos. 12/026,582, entitled “SYSTEM AND METHOD FOR CONTROLLING A SAFETY RESTRAINT STATUS BASED ON DRIVER STATUS” and filed on Feb. 6, 2008; 12/026,857, entitled “SYSTEM AND METHOD FOR CONTROLLING EARLY LOW FUEL WARNING BASED ON DRIVER STATUS” and filed on Feb. 6, 2008; 12/026,867, entitled “SYSTEM AND METHOD FOR CONTROLLING ELECTRONIC STABILITY CONTROL BASED ON DRIVER STATUS” and filed on Feb. 6, 2008; and 12/026,872, entitled “SYSTEM AND METHOD FOR CONTROLLING OBJECT DETECTION BASED ON DRIVER STATUS” and filed on Feb. 6, 2008, are illustrative of the types of functionality or operations that may be selectively controlled based on the driver status of the vehicle. It is contemplated that additional safety and/or notification features may be controlled based on the driver status of vehicle and that the foregoing features noted above are not intended to be an exhaustive listing of the safety and/or notification features that may be controlled based on the driver status.

The manner in which a vehicle occupant programs each of the keys 20, 22 as a primary key or a secondary key to the vehicle and the manner in which the LUT stores data corresponding to the ‘TYPE’ is disclosed in co-pending U.S. patent Ser. No. 12/139,005, entitled “SYSTEM AND METHOD FOR PROGRAMMING KEYS TO ESTABLISH PRIMARY AND SECONDARY DRIVERS” and filed on Jun. 13, 2008.

Spare key 28 is defined as a key that is not programmed to the vehicle (e.g., cannot be used to start the vehicle). In general, the system 10 is configured to enable a vehicle occupant to program a spare key 28 having an IKD 30 to the vehicle so that data corresponding to the key serial number, the manufacturing code, and corresponding encrypted data for the spare key 28 is stored in the LUT so that the key 28 is later recognized by the PATS controller 16 as being an authorized (or programmed) key to start the vehicle. The key 28 transmits such data on a signal KEY_ID_3 to the PATS controller 16. Once the corresponding information related to the spare key 28 is stored in the LUT (e.g., key serial number, manufacturing code, and corresponding encrypted data) after programming the spare key 28 to the vehicle, the PATS controller 16 designates (or assigns) the primary key or the secondary key and indicates that the key 28 has a ‘TYPE’ in the LUT that is either a primary key or a secondary key.

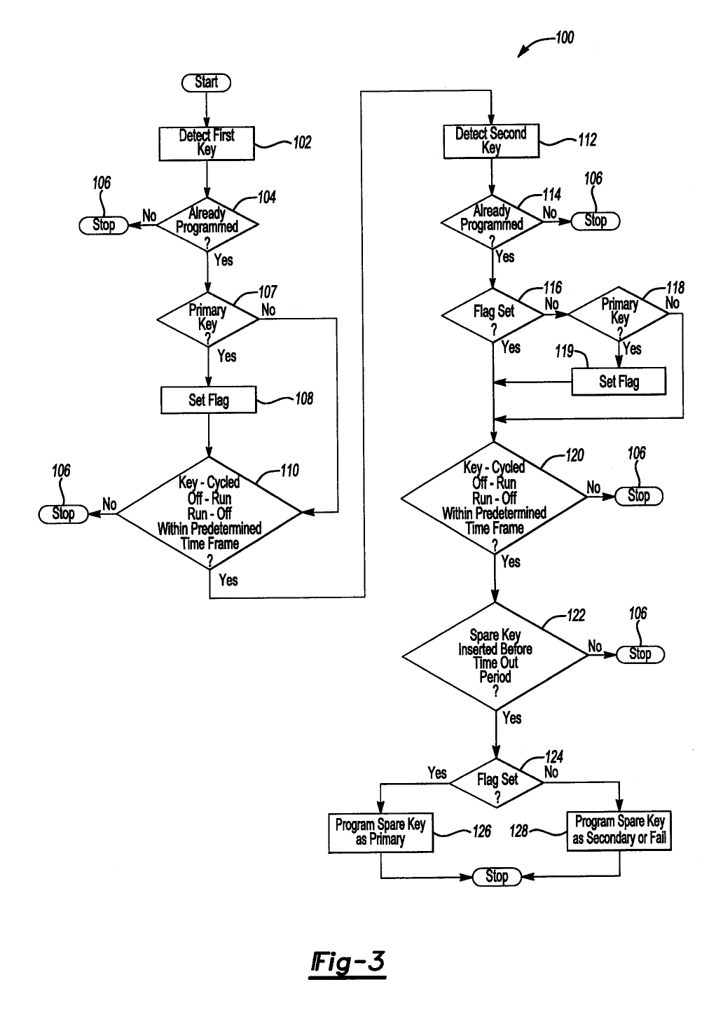

To program the spare key 28 to the vehicle, the occupant may need to perform various operations with at least one of the already authorized (or programmed) keys 20, 22. These operations will be discussed in more detail in connection with FIG. 3. In one example, the PATS controller 16 may require that at least one of the keys 20, 22 used to enable the spare key 28 to be programmed to the vehicle be a primary key (e.g., that at least one of the keys 20, 22 have a ‘TYPE’ that is equal to a primary key). Such a condition may ensure that the occupant programming the spare key 28 is a primary driver since the primary driver is presumed to have access to the primary key. This condition may ensure that the secondary driver cannot use his/her secondary key to program a spare key 28 to the PATS controller 16 so that the programmed key 28 attains primary key status thereby granting the secondary driver rights that are designated for the primary driver.

In another example, in the event all of the keys 20, 22 used to enable the spare key 28 to be programmed to the vehicle are secondary keys, the PATS controller 16 may designate the spare key 28 as a secondary key after spare key programming so that the secondary driver is prevented from attaining primary driver rights. The status of the spare key 28 once programmed can be changed from a primary key to a secondary key or from a secondary key to a primary key as noted in the aforementioned co-pending application, U.S. Ser. No. 12/139,005, entitled “SYSTEM AND METHOD FOR PROGRAMMING KEYS TO ESTABLISH PRIMARY AND SECONDARY DRIVERS” and filed on Jun. 13, 2008.

Referring now to FIG. 2, a system 50 for programming a spare key to a vehicle in accordance to one embodiment of the present invention is shown. The system 50 includes the vehicle interface device 12, the body electronics controller 14, a passive entry passive start (PEPS) controller 52, a backup slot 54 and a start/stop switch 55. While FIG. 2 generally illustrates that the PEPS controller 52 is positioned external to the device 12, additional implementations may include positioning the PEPS controller 52 within the device 12 or any other controller in the vehicle. The particular placement of the PEPS controller 52 may vary based on the desired criteria of a particular implementation.

In general, the PEPS function is a keyless access and start system. The driver may own at least two programmed keys 56, 58 that may each be in the form of an electronic transmission device (e.g., a key fob). With the PEPS implementation, the driver (or other occupant) is not required to use a mechanical key blade to open the door of the vehicle or to start the vehicle. Each key 56, 58 may include a mechanical key to ensure that the driver can access and start the vehicle in the event one or more of the keys 56, 58 exhibit low battery power. Keys 56, 58 include an ignition key device (IKD) 60, 62, respectively, embedded therein for communicating with the PEPS controller 52. Each IKD 56, 58 includes a transponder (not shown). Each transponder includes an integrated circuit and an antenna. Each transponder for the keys 56, 58 is adapted to send the key number and encrypted data on signals KEY_ID_1 and KEY_ID_2, respectively, as RF signals to a receiver (not shown) in the PEPS controller 52.

To gain access or entry into the vehicle with the key 56 or 58 in the PEPS implementation, the driver may need to wake up the PEPS controller 52 to establish bi-directional communication between the key 56 or 58 and the PEPS controller 52. In one example, the wake up may occur by requiring the driver to touch and/or pull the door handle of the vehicle. In response to the door handle being toggled or touched, the PEPS controller 52 may wake up and transmit RF based signals to the key 56 or 58 via a transmitter (not shown). The PEPS controller 52 and the key 56 or 58 may undergo a series of communications back and forth with each other (e.g., handshaking) for vehicle access authentication purposes. The PEPS controller 52 may unlock the doors in response to successful completion of the handshaking process. Once the driver is in the vehicle, the driver may select the start/stop switch 55 to start the vehicle.

Prior to starting the vehicle, the key serial number and/or the encrypted data are compared to known key numbers and/or encrypted data in a look up table (LUT) (within the PEPS controller 52) in a manner similar to that described in connection with FIG. 1. The LUT used in connection with the PEPS implementation is generally similar to the LUT as shown in Table 1. In one example, the manufacturing code is also checked at the time of programming the keys 56, 58 to ensure the key is used for a particular manufacturer of the vehicle.

The driver status (e.g., key status) for each key that is programmed to the vehicle is shown under the ‘TYPE’ heading. The status of the key will change from primary to secondary in response to the user programming a particular key via the device 12. This method is disclosed in the aforementioned co-pending application U.S. Ser. No. 12/139,005, entitled “SYSTEM AND METHOD FOR PROGRAMMING KEYS TO ESTABLISH PRIMARY AND SECONDARY DRIVERS” and filed on Jun. 13, 2008.

The PEPS controller 52 ascertains the key status (or driver status) of the key 56, 58 (e.g., whether primary or secondary) by decoding the key number and/or encrypted data received on one of the signals KEY_ID_1 and KEY_ID_2 depending on which key 56, 58 is used and looking up the corresponding key type (e.g., primary or secondary) under the ‘TYPE’ heading of the LUT. The PEPS controller 52 is configured to transmit the signal KEY_STATUS on the communication bus to the device 12. The PEPS controller 52 and/or the device 12 may transmit the signal KEY_STATUS to any controller or module in the vehicle so that the functionality or operation performed by a particular controller (or module) may be selectively controlled based on the driver status. The PEPS controller 52 may also transmit the signal IGN_SW_STS to the cluster 22. The PEPS controller 52 determines that the key ignition status is in the run position in response to the driver toggling the brake pedal and depressing the start switch.

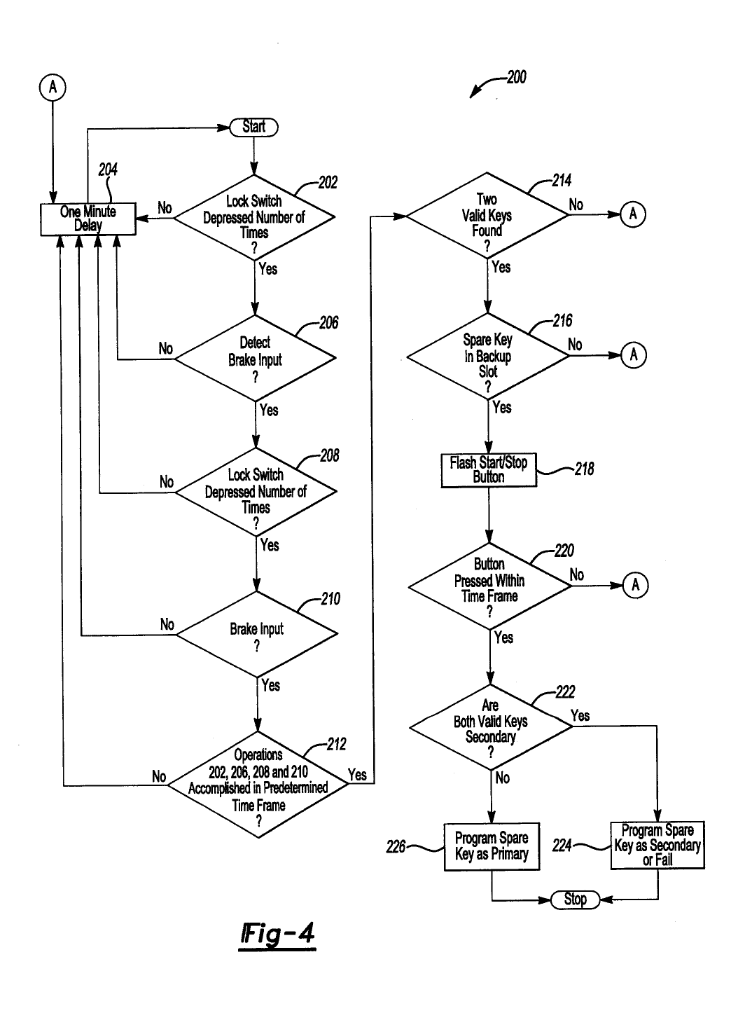

A lock/unlock switch 61 is electrically coupled to the body electronics controller 14. The body electronics controller 14 unlocks/locks one or more doors (not shown) in the vehicle in response to signals from the lock/unlock switch 61. The body electronics controller 14 transmits a signal LOCK_STATUS to the PEPS controller 52. The signal LOCK_STATUS corresponds to the lock status of the doors of the vehicle (e.g., are the doors in a “locked” or “unlocked” state). The body electronics controller 14 may transmit the signal LOCK_STATUS to indicate the lock or unlocked state of the doors in response to the lock/unlock switch 61 being depressed. The body electronics controller 14 receives a signal BRAKE_STS which is indicative of whether a brake pedal is being depressed (e.g., whether the brakes are being applied). The body electronics controller 14 transmits the signal BRAKE_STS to the PEPS controller 52. The relevance of the signals LOCK_STATUS and BRAKE_STS will be discussed in more detail in connection with FIG. 4.

In general, the system 50 is configured to enable a vehicle occupant to program a spare key 64 having an IKD 66 to the vehicle so that data corresponding to the key serial number, the manufacturing code, corresponding encrypted data for the spare key 64 is stored in the LUT and the key 64 is later recognized by the PEPS controller 52 as an authorized key to start the vehicle. The key 64 transmits such data on the signal KEY_ID_3 to the PEPS controller 52. The PEPS controller 52 also designates (or assigns) the spare key 64 as a primary key or a secondary key and stores such status under the ‘TYPE’ heading for the programmed spare key 64.

To program the spare key 64 to the vehicle, the occupant may need to perform various operations with at least one of the already authorized (or programmed) keys 56, 58. These operations will be discussed in more detail in connection with FIG. 4. In one example, the PEPS controller 52 may require that at least one of the keys 56,58 is in the vehicle and that such a key 56, 58 be designated as a primary key (e.g., that at least one of the keys 56, 58 have a ‘TYPE’ that is equal to the primary key) to enable the spare key 64 to be programming to the vehicle and to designate the newly programmed spare key 64 as a primary key. Such a condition ensures that the occupant programming the spare key 64 is a primary driver since the primary driver is presumed to have access to the primary key. This condition may ensure that the secondary driver cannot use his/her secondary key to program a spare key 64 to the PEPS controller 52 so that the programmed spare key 64 attains primary key status.

In another example, in the event all of the keys 56, 58 in the vehicle are secondary keys, the PEPS controller 52 may designate the programmed spare key 64 as a secondary key so that the secondary driver cannot obtain primary rights. The status of the spare key 64 once programmed can be changed from a primary key to a secondary key or from a secondary key to a primary key as noted above.

Referring now to FIG. 3, a method 100 for programming the spare key 28 to the vehicle in accordance to one embodiment of the present invention is shown. The PATS controller 16 may include, but not limited to, a number of microprocessors, ICs, memory devices (e.g., FLASH, ROM, RAM, EPROM and/or EEPROM), receivers/transmitters and software modules which co-act with one another to perform the operations of method 100 as noted below. One or more of the operations described below may be modified, omitted or rearranged as needed based on the desired criteria of a particular implementation. The method 100 describes a number of vehicle operations that are performed to program the spare key to the vehicle. Such vehicle operations listed herein are examples and it is contemplated that any vehicle operation that is capable of being monitored in response to occupant actuation can be used. Further, the method 100 provides a number of operations that are performed more than once. It is contemplated that any of the number of operations can be performed once.

In operation 102, the PATS controller 16 detects that a first key 20 or 22 is inserted. In one example, the body electronics controller 14 detects that the first key 20 or 22 is inserted by monitoring whether the ignition switch 19 is cycled between the OFF and RUN positions or ACCY or RUN positions via the signal IGN_SW_STS. In another example, the body electronics controller 14 detects that the first key 20 or 22 is inserted and transmits the signal IGN_SW_STS which indicates that the key 20 or 22 is inserted and also indicates the position of the ignition switch 19. The PATS controller 16 receives the signal IGN_SW_STS and detects that the key is inserted into the ignition switch 19.

In operation 104, the PATS controller 16 determines whether the first key 20 or 22 has already been programmed to the vehicle. For example, the PATS controller 16 receives the signal KEY_ID_1 or KEY_ID_2 depending on which key 20, 22 is inserted and compares the key serial number and/or corresponding encrypted data on the signals KEY_ID_1 or KEY_ID_2 to the corresponding data in the LUT to determine if the first key 20, 22 is programmed. If the key serial number and/or corresponding encrypted data on the signals KEY_ID_1 or KEY_ID_2 does not match the corresponding data in the LUT, then the PATS controller 16 determines that the first key 20 or 22 is not programmed to the vehicle. In this case, the method 100 moves to operation 106.

If the key serial number and/or corresponding encrypted data on the signals KEY_ID_1 or KEY_ID_2 matches the corresponding data in the LUT, then the PATS controller 16 determines that the first key 20 or 22 is programmed to the vehicle. In this case, the method 100 moves to operation 107.

In operation 106, the PATS controller 16 determines an error and the method 100 stops.

In operation 107, the PATS controller 16 determines whether the first key 20 or 22 is a primary key. The PATS controller 16 determines the key status (e.g., primary or secondary key) by cross-referencing the key serial number and/or the encrypted data received on the signal KEY_ID_1 or KEY_ID_2 in the LUT and locating the appropriate status under the ‘TYPE’ heading. If the first key 20 or 22 is determined to be the primary key, then the method 100 moves to operation 108. If the first key 20 or 22 is determined to be the secondary key, then the method 100 moves to operation 110.

In operation 108, the PATS controller 16 sets a flag in response to determining that the first key 20 or 22 is a primary key.

In operation 110, the PATS controller 16 determines whether the first key 20 or 22 that is currently in the key ignition switch 19 has been cycled between the OFF-RUN position and the RUN-OFF position a preselected number of times within a predetermined time-frame. In one example, the predetermined time-frame may correspond to 10 seconds. It is generally contemplated that the predetermined time-frame may vary based on the desired implementation. In this operation, the PATS controller 16 monitors the signal IGN_SW_STS to determine whether the first key 20 or 22 has been cycled between the OFF-RUN position and the RUN-OFF positions. If the first key 20 or 22 has not been cycled between the OFF-RUN position and the RUN-OFF position a preselected number of times within the predetermined time frame, the method 100 moves back to operation 106. If the first key 20 or 22 has cycled between the OFF-RUN position and the RUN-OFF position a preselected number of times within the predetermined time frame, then the method 100 moves to operation 112. It is noted that the particular ignition switch positions used in which the first key 20 or 22 is cycled may also vary based on the desired criteria of a particular implementation.

In operation 112, the PATS controller 16 detects that a second key 20 or 22 is inserted (e.g., see operation 102).

In operation 114, the PATS controller 16 determines whether the second key 20 or 22 has already been programmed to the vehicle. For example, the PATS controller 16 receives the signal KEY_ID_1 or KEY_ID_2 depending on which key 20, 22 is inserted and compares the key serial number, and/or corresponding encrypted data on the signals KEY_ID_1 or KEY_ID_2 to the corresponding data in the LUT to determine if the second key 20 or 22 is programmed. If the key serial number, and/or corresponding encrypted data on the signals KEY_ID_1 or KEY_ID_2 does not match the corresponding data in the LUT, then the PATS controller 16 determines that the second key 20 or 22 is not programmed to the vehicle. In this case, the method 100 moves to operation 106.

If the key serial number and/or corresponding encrypted data on the signals KEY_ID_1 or KEY_ID_2 matches the corresponding data in the LUT, then the PATS controller 16 determines that the second key 20 or 22 is programmed to the vehicle. In this case, the method 100 moves to operation 116.

In operation 116, the PATS controller 16 determines whether the flag is set. If the PATS controller 16 determines that the flag is not set, then the method 100 moves to operation 118 to check if the second key 20 or 22 is detected to be a primary key. If the PATS controller 16 determines that the flag is set, then the method 100 moves to operation 120. Such a condition would indicate that the first key 20 or 22 was detected to be a primary key (see operation 108). In order to program the spare key to the vehicle and to ensure that the spare key is designated as the primary key, either the first key or the second key is required to have a primary key status.

In operation 118, the PATS controller 16 determines whether the second key 20 or 22 is a primary key. The PATS controller 16 determines the key status (e.g., primary or secondary key) by cross-referencing the key serial number and/or the encrypted data received on the signal KEY_ID_1 or KEY_ID_2 in the LUT and locating the appropriate status of key under the ‘TYPE’ heading. If the second key 20 or 22 is determined to the primary key, then the method 100 moves to operation 119. Such a condition indicates that the occupant is attempting to program the spare key 28 in which the second key 20, 22 is a primary key.

If the second key 20 or 22 is determined to be the secondary key, then the method 100 moves to operation 120. Such a condition indicates the occupant is attempting to program the spare key 28 in which the first and the second keys 20, 22 are secondary keys.

In operation 119, the PATS controller 16 sets a flag in response to determining that the second key 20 or 22 is a primary key.

In operation 120, the PATS controller 16 determines whether the second key 20 or 22 that is currently in the key ignition switch 19 has been cycled between the OFF-RUN position and the RUN-OFF position a preselected number of times within a predetermined time-frame. Again, in one example, the predetermined time-frame may correspond to 10 seconds. It is generally contemplated that the predetermined time-frame may vary based on the desired implementation. In this operation, the PATS controller 16 monitors the signal IGN_SW_STS to determine whether the second key 20 or 22 has been cycled between the OFF-RUN position and the RUN-OFF positions. If the second key 20 or 22 has not been cycled between the OFF-RUN position and the RUN-OFF position a preselected number of times within the predetermined time frame, the method 100 moves to back to operation 106. If the second key 20 or 22 has cycled between the OFF-RUN position and the RUN-OFF position a preselected number of times within the predetermined time frame, then the method 100 moves to operation 122. It is noted that the particular ignition switch positions used in which the second key 20 or 22 is cycled between within the predetermined time frame may also vary based on the desired criteria of a particular implementation.

In operation 122, the PATS controller 16 determines whether the spare key 28 has been inserted into the ignition switch 19 within a predetermined time frame. The predetermined time frame may be 10 seconds or other suitable value. The PATS controller 16 may monitor whether the spare key 28 has been inserted into the ignition switch 19 by monitoring the signal KEY_ID_3 or the signal IGN_SW_STS. If the spare key 28 has not been inserted into the ignition switch 19 within the predetermined time frame, then the method 100 moves to operation 106. If the spare key 28 has been inserted into the ignition switch 19 within the predetermined time frame, then the method 100 moves to operation 124.

In operation 124, the PATS controller 16 determines whether the flag is set. Such a condition would indicate that the first and/or the second key 20, 22 was detected to be a primary key (see operation 108). In order to program the spare key 28 to the vehicle and to ensure that the spare key 28 is designated as the primary key, either the first key or the second key is required to have a primary key status. If the PATS controller 16 determines that the flag is set, then the method 100 moves to operation 126.

If the PATS controller 16 determines that the flag is not set, such a condition indicates that the driver is attempting to program the spare key 28 to the vehicle with two secondary keys. The method 100 moves to operation 128.

In operation 126, the PATS controller 16 stores the data on the signal KEY_ID_3 into the LUT to program the key 28 to the vehicle and assigns the data on the signal KEY_ID_3 to correspond to the primary key. For example, the PATS controller 16 stores the key serial number, the manufacturing code, and the encrypted data in the LUT and assigns such data to correspond to the primary key (or the primary driver). As illustrated above, so long as one of the first and the second keys 20, 22 are detected to be the primary key and the remaining conditions are met with respect to programming the spare key 28 to the vehicle, then the spare key 28 is programmed as the primary key. The PATS controller 16 transmits a signal FEEDBACK to the device 12 so that the device 12 communicates to the occupant that the spare key 28 has been successfully programmed to the vehicle. The device 12 may further communicate to the occupant that the spare key 28 has been programmed as the primary key.

In operation 128, the PATS controller 16 stores the data on the signal KEY_ID_3 into the LUT to program the key 28 to the vehicle and assigns the data on the signal KEY_ID_3 to correspond to the secondary key. For example, the PATS controller 16 stores the key serial number, the manufacturing code, and the encrypted data in the LUT and assigns such data to correspond to the secondary key (or the secondary driver). As illustrated above, since the first and the second keys 20, 22 are detected to be the secondary keys and the remaining conditions are met with respect to programming the spare key 28 to the vehicle, then the spare key 28 is programmed as the secondary key. The PATS controller 16 transmits a signal FEEDBACK to the device 12 so that the device 12 communicates to the occupant that the spare key 28 has been successfully programmed to the vehicle. The device 12 may further communicate to the occupant that the spare key 28 has been programmed as the primary key.

In another implementation, in the event both keys 20, 22 are detected to be secondary keys, the PATS controller 16 may simply fail to program the spare key 28.

Referring now to FIG. 4, a method 200 for programming the spare key 64 to the vehicle in accordance to one embodiment of the present invention is shown. The PEPS controller 52 may include, but not limited to, a number of microprocessors, ICs, memory devices (e.g., FLASH, ROM, RAM, EPROM and/or EEPROM), receivers/transmitters and software modules which co-act with one another to perform the operations of method 200 as described below. The method 200 describes a number of vehicle operations that are performed to program the spare key 64 to the vehicle. Such vehicle operations listed herein are examples and it is contemplated that any vehicle operation that is capable of being monitored in response to occupant actuation can be used. Further, the method 200 provides a number of operations that are performed more than once. It is contemplated that any of the number of operations can be performed once.

In operation 202, the PEPS controller 52 determines whether the door lock switch 61 has been depressed a predetermined number of times. For example, the PEPS controller 52 receives and monitors the signal LOCK_STATUS (e.g., locking or unlocking of the doors via the door lock switch 61) to determine the number of times the door lock switch 61 has been depressed. In one example, the predetermined number of times may correspond to 3 switch actuations of the door lock switch 61. The particular number of switch actuations may vary based on the desired criteria of a desired implementation. While the PEPS controller 52 monitors switch actuations related to the door lock switch 61, the system 50 and method 200 may monitor any such vehicle operation that is capable of being toggled by the vehicle occupant. For example, the PEPS controller 52 may monitor, among other things, the number of times the head lights were turned on, the locking/unlocking of the vehicle with a key fob, or other suitable operation that requires vehicle occupant input.

If the PEPS controller 52 detects that the door lock switch 61 has not been toggled the predetermined number of times, the method 200 moves to operation 204. If the PEPS controller 52 detects that the door lock switch 61 has been toggled the predetermined number or times, the method 200 moves to operation 206.

In operation 204, the PEPS controller 52 initiates a one-minute delay (or other suitable time delay) so that the occupant can restart the operation of programming the spare key 64 to the vehicle.

In operation 206, the PEPS controller 52 determines whether the brakes have been applied by monitoring the signal BRAKE_STS. If the PEPS controller 52 determines that the brakes have not been applied, the method 200 moves to back to operation 204. If the PEPS controller 52 determines that the brakes have been applied, the method 200 moves to operation 208. As noted in connection with operation 202, any such operation that is configured to elicit a response (and the frequency in which a particular operation is performed) from the vehicle occupant can be used. In addition, the frequency or number of times such an operation can be performed may vary based on the desired criteria of a particular implementation.

In operation 208, the PEPS controller 52 determines whether the door lock switch 61 has been depressed a predetermined number of times. Operation 208 may be performed in a similar manner as that noted in connection with operation 202. If the PEPS controller 52 determines that the door lock switch 61 has not been depressed the predetermined number of times, then the method 200 moves back to operation 204. If the PEPS controller 52 determines that the door lock switch 61 has been depressed the predetermined number of times, then the method 200 moves to operation 210.

In operation 210, the PEPS controller 52 determines whether the brakes have been applied by monitoring the signal BRAKE_STS. Operation 210 may be performed in a similar manner to that of operation 206. If the PEPS controller 52 determines that the brakes have not been applied, the method 200 moves back to operation 204. If the PEPS controller 52 determines that the brakes have been applied, the method 200 moves to operation 212.

In operation 212, the PEPS controller 52 determines whether the operations 202, 206, 208 and 210 have been successfully performed within a predetermined time frame. In one example, the predetermined time frame may be 30 sec. The particular value used for the time frame may be varied to meet the design criteria of a particular implementation. If the operations 202, 206, 208, and 210 have not been successfully performed within the predetermined time frame, then the method 200 moves back to operation 204. If the operations 202, 206, 208, and 210 have been successfully performed within the predetermined time frame, then the method 200 moves to operation 214.

In operation 214, the PEPS controller 52 determines the number of programmed keys (e.g., keys 56, 58) that are in the vehicle. For example, the PEPS controller 52 determines the number of keys that are present in the vehicle by monitoring the signals KEY_ID_1 and KEY_ID_2. If there are less than two keys detected in the vehicle, then the method 200 moves back to operation 204. If there are two or more keys detected in the vehicle, then the method 200 moves to operation 216. While the above operation notes that two or more keys are to be detected in the vehicle, it is contemplated that only a single key may need to be detected. Enhanced security may be realized by increasing the number of keys that have to be detected. The PEPS controller 52 presumes that if two or more keys are detected in the vehicle, such a condition generally implies that the occupant programming the spare key 64 to the vehicle is authorized to do so because it is presumed that the occupant would have access to two or more keys whereas an unauthorized occupant may have access to a single key.

In operation 216, the PEPS controller 52 determines whether the spare key 64 (e.g., non programmed key) is electrically coupled to the back up slot 54. For example, the back up slot 54 may include a transceiver that is electrically excited in response to detecting that the spare key 64 is positioned a predetermined distance therefrom. The transceiver detects that the key 64 is within the predetermined distance by monitoring RF signals transmitted from the key 64. The transceiver transmits RF signal(s) to the PEPS controller 52 in response to detecting the presence of the key 64. The PEPS controller 52 determines that the key 64 is electrically coupled to the back up slot 54 in response to receiving RF signal(s) from the transceiver 64.

If the spare key 64 is not detected to be in the backup slot 54, then the method 200 moves back to operation 204. If the spare key 64 is detected to be in the backup slot 54, then the method 200 moves to operation 218.

In operation 218, the PEPS controller 52 controls the start/stop switch 54 to flash indicating that the programming mode has been entered into and that two previously programmed keys 56, 58 have been detected in the vehicle.

In operation 220, the PEPS controller 52 monitors whether the start/stop switch 55 has been depressed within a predetermined time frame. The predetermined time frame as used in this operation may correspond to one minute or other suitable value. If the start/stop switch 55 has not been depressed within the predetermined time frame, then the method 200 moves back to operation 204. If the start/stop switch 55 have been depressed within the predetermined time frame, then the method 200 moves to operation 222.

In operation 222, the PEPS controller 52 determines whether the number of keys 56, 58 detected to be in the vehicle are each secondary keys. The PEPS controller 52 determines the key status (e.g., primary or secondary key) by cross-referencing the key serial number and/or the encrypted data received on the signal KEY_ID_1 or KEY_ID_2 in the LUT and locating the appropriate type of key under the ‘TYPE’ heading. If both of the keys 56, 58 are detected to be a secondary key, then the method 200 moves to operation 224. If at least one of the keys 56, 58 are detected to be a primary key, then the method 200 moves to operation 226.

In operation 224, the PEPS controller 52 stores the data on the signal KEY_ID_3 into the LUT to program the key 64 to the vehicle and assigns the data on the signal KEY_ID_3 to correspond to the secondary key. For example, the PEPS controller 52 stores the key serial number, the manufacturing code, and the encrypted data in the LUT and assigns such data to correspond to the secondary key (or driver). As illustrated above, since the first and the second keys 56, 58 are detected to be the secondary keys and the remaining conditions are met with respect to programming the spare key 64 to the vehicle, then the spare key 64 is programmed as the secondary key. The PEPS controller 52 transmits a signal FEEDBACK to the device 12 so that the device 12 communicates to the occupant that the spare key 64 has been successfully programmed to the vehicle. The device 12 may further communicate to the occupant that the spare key 64 has been programmed as the primary key.

In another implementation, in the event both keys 56, 58 are detected to be secondary keys, the PEPS controller 52 may simply fail to program the spare key 64.

In operation 226, the PEPS controller 52 stores the data on the signal KEY_ID_3 into the LUT to program the key 64 to the vehicle and assigns the data on the signal KEY_ID_3 to correspond to the primary key. For example, the PEPS controller 52 stores the key serial number, the manufacturing code, and the encrypted data in the LUT and assigns such data to correspond to the primary key (or driver). As illustrated above, so long as one of the first and the second keys 56, 58 are detected to be the primary key and the remaining conditions are met with respect to programming the spare key 64 to the vehicle, then the spare key 64 is programmed as the primary key. The PEPS controller 52 transmits a signal FEEDBACK to the device 12 so that the device 12 communicates to the occupant that the spare key 64 has been successfully programmed to the vehicle. The device 12 may further communicate to the occupant that the spare key 64 has been programmed as the primary key.

While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method for assigning a driver status of one of a primary and second driver to a spare key, the method comprising:
receiving a first key identification signal from a first key indicative of the driver status being one of the primary and the secondary driver;
receiving a spare key identification signal; and
assigning the spare key identification signal to correspond to the driver status as indicated on the first key identification signal.

2. The method of claim 1 wherein receiving the spare key identification signal further comprises receiving the spare key identification signal that includes data therein that has not been stored to the vehicle.

3. The method of 2 further comprising detecting an occurrence of at least one predetermined vehicle operation prior to assigning the spare key identification signal.

4. The method of claim 3 further comprising electronically storing the data to the vehicle responsive to detecting the occurrence of the at least one predetermined vehicle operation to program the spare key to the vehicle.

5. The method of claim 3 wherein detecting the occurrence of at least one predetermined vehicle operation further comprises detecting an occurrence of inserting the first key into the ignition switch and cycling an ignition switch a predetermined number of times.

6. The method of claim 3 wherein detecting the occurrence of at least one predetermined vehicle operation further comprises detecting an occurrence of at least one of locking one or more doors of the vehicle a predetermined number of times and determining whether brakes have been applied.

7. A device for assigning a driver status of one of a primary driver and a secondary driver to a spare key, the device comprising:
a controller configured to:
receive a first key identification signal from a first key indicative of the driver status being one of the primary and the secondary driver;
determine whether the driver status indicated on the first key identification signal corresponds to the one of the primary driver and the secondary driver;
receive a spare key identification signal; and
assign the spare key identification signal to correspond to the driver status as indicated on the first key identification signal.

8. The device of claim 7 wherein the spare key identification signal includes data therein that has not been stored to the vehicle.

9. The device of claim 8 wherein the controller is further configured to detect an occurrence of at least one predetermined vehicle operation.

10. The device of claim 9 wherein the controller is further configured to electronically store the data in response to detecting the occurrence of the at least one predetermined vehicle operation for programming the spare key to the vehicle.

11. The device of claim 9 wherein the controller is further configured to detect an occurrence of at least one of the first key being inserted into the ignition switch and an ignition switch being cycled a predetermined number of times.

12. The device of claim 9 wherein the controller is further configured to detect an occurrence of at least one of locking one or more doors of the vehicle a predetermined number of times and determining whether brakes have been applied.

13. The device of claim 7 wherein the controller is a passive anti-theft security (PATS) controller.

14. The device of claim 7 wherein the controller is a passive entry passive start (PEPS) controller.

15. A device for assigning a driver status of one of a primary driver and a secondary driver to a spare key, the device comprising:
a controller configured to:
receive a first key identification signal from a first key indicative of the driver status for the first key being that of one of the primary driver and the secondary driver;
receive a second key identification signal from a second key indicative of the driver status for the second key being that of one of the primary driver and the secondary driver;
determine whether the driver status indicated on at least one of the first key identification signal and the second key identification signal corresponds to the primary driver;
receive a spare key identification signal; and
assign the spare key identification signal to correspond to the primary driver if the driver status indicated on the at least one of the first key identification signal and the second key identification signal corresponds to the primary driver.

16. The device of claim 15 wherein the spare key identification signal includes data therein that has not been stored to the vehicle from the spare key.

17. The device of claim 16 wherein the controller is further configured to detect an occurrence of at least one predetermined vehicle operation.

18. The device of claim 17 wherein the controller is further configured to electronically store the data in response to detecting the occurrence of the at least one predetermined vehicle operation to program the spare key to the vehicle.

19. The device of claim 17 wherein the controller is further configured to detect an occurrence of at least one of the first key being inserted into the ignition switch and an ignition switch being cycled a predetermined number of times.

20. The device of claim 17 wherein the controller is further configured to detect an occurrence of at least one of locking one or more doors of the vehicle a predetermined number of times and determining whether brakes have been applied.
